(19) United States
(12) Patent Application Publication
(10) Pub. No.: US 2011/0234644 A1
(43) Pub. Date: Sep. 29, 2011

(54) DISPLAY DEVICE, IMAGE SIGNAL CORRECTION SYSTEM, AND IMAGE SIGNAL CORRECTION METHOD

(76) Inventors: Kyong-Tae PARK, Yongin-City (KR); Alexander Arkhipov, Yongin-city (KR); Baek-Woon Lee, Yongin-city (KR); Seon-Min Kim, Yongin-city (KR)

(21) Appl. No.: 12/902,466

(22) Filed: Oct. 12, 2010

(30) Foreign Application Priority Data
Mar. 25, 2010 (KR) 10-2010-0026853

(51) Int. Cl. G09G 5/10

(52) U.S. Cl. 345/690

(57) ABSTRACT

A display device includes a display unit and a controller, the controller generating and transmitting a scan signal and an image data signal to a scan driver and a data driver, respectively. The controller includes a memory unit storing a look-up table of basic correction amounts for a test image data signal according a comparison result of comparing a measured value of an image of the display unit displaying the test image data signal with a target value of the test image data signal, and a data controller storing data for a modulation coefficient for applying the look-up table to the supplied image data signal, calculating a full correction amount corresponding to the supplied image data signal using the modulation coefficient and the basic correction amount of the look-up table, and outputting a corrected image data signal by correcting the supplied image data signal by the full correction amount.

### BACKGROUND

1. Field of the Invention

Embodiments relate to a display device, an image signal correction system, and an image signal correction method.

2. Description of the Related Art

Various kinds of flat display devices that are capable of reducing the weight and size of cathode ray tubes (CRT) have been developed in recent years. Such flat display devices include liquid crystal displays (LCDs), field emission displays (FEDs), plasma display panels (PDPs), and organic electroluminescence display devices.

Among the flat panel displays, OLED display displays an image by using an OLED that generates light according to recombination of electrons and holes. The OLED display receives much attention due to its fast response speed, low power consumption, high luminance, and wide viewing angle. Further, the OLED display has excellent color reproducibility and can be slim, so it can be applied to various markets including mobile phones, PDAs, MP3 Players, TVs, and monitors.

Recently, research and development for increasing the size of the OLED display have been carried out actively. However, in order to increase the OLED display in size, non-uniformity of a thin film transistor of a pixel should be addressed, as well as other problems that arise due to the increased size, i.e. are not at issue for small-sized OLED displays. These problems includes power line IR voltage drop, OLED cavity length non-uniformity, and loading effect should be solved.

However, when a conventional correction method is used to solve the problems, the memory size and product cost may increase while decreasing the yield. Accordingly, a correction method of a large-sized display device for minimizing the memory size while improving the yield, reducing product cost, and correcting a wave shift generated according to a location of a large-sized display panel is required.

The above information disclosed in this Background section is only for enhancement of understanding of the background of the invention and therefore it may contain information that does not form the prior art that is already known in this country to a person of ordinary skill in the art.

### SUMMARY

Embodiments are therefore directed to a device and method, which substantially overcome one or more of the problems due to the limitations and disadvantages of the related art.

It is therefore a feature of an embodiment to provide a device that improves image quality by enhancing uniformity through measurement and correction of luminance and color of light emitted from a larger display device, and a method thereof.

It is another feature of an embodiment to provide a display device using an image signal correction system that can compensate for non-uniformity of a thin film transistor in a pixel of the display device.

It is yet another feature of an embodiment to provide a large display device that can be mass produced and that addresses power IR drop, OLED cavity non-uniformity, and loading effect.

It is still another feature of an embodiment to provide an image signal correction method for mass production of a display device with improved yield and reduced production cost, while also providing a display device which compensates for pixel non-uniformity, e.g., in mid-sized or large display panels, using a minimal amount of memory to provide a display device of which image quality is improved through correction of wavelength shift that occurs according to a location on the display panel.

At least one of the above and other features and advantages may be realized by providing a display device, including a display unit displaying an image of a supplied image data signal, a scan driver supplying a scan signal to the display unit, a data driver supplying an image data signal to the display unit according to the scan signal, and a controller connected with the scan driver and the data driver, the controller generating and transmitting the scan signal and the image data signal, wherein the controller includes, a memory unit storing a look-up table of basic correction amounts for a test image data signal according a comparison result of comparing a measured value of an image of the display unit displaying the test image data signal with a target value of the test image data signal, and a data controller storing data for a modulation coefficient for applying the look-up table to the supplied image data signal, calculating a full correction amount corresponding to the supplied image data signal using the modulation coefficient corresponding to the supplied image data signal and the basic correction amount of the look-up table, and outputting a corrected image data signal by correcting the supplied image data signal using the full correction amount.

The measured value and the target value may be measured optical tristimulus values with respect to a luminance measured value and a color measured value acquired by light emission measurement of the display unit and target optical tristimulus values with respect to a luminance target value and a color target value.

The basic correction amount of the test image data may be generated from a correction value obtained by comparing measured optical tristimulus values from at least one light emitting portion of the display unit displaying the test image data with target optical tristimulus values, and correcting a corresponding color-specific data signal from a measured optical tristimulus value having a largest difference from a corresponding target optical tristimulus value, and a correction value obtained by iteratively correcting the color-specific data signal corresponding to measured optical tristimulus value until the measured optical tristimulus value converges to the target tristimulus value.

The iteratively correcting the color-specific data signal may include adding or subtracting compensating R, G, or B grayscale data to corresponding R, G, or B grayscale data.

The controller may further include a data location tracker that tracks a location of a correction amount corresponding to grayscale data of a supplied image data signal in the look-up table stored in the memory unit.

The data controller may further include a plurality of data controllers corresponding to predetermined areas partitioned according to grayscale data, each of the plurality of data controllers correcting the image data signal using modulation coefficients calculated for each area and a correction amount of the look-up table stored in the memory unit and outputting a corrected image data signal.

The modulation coefficients calculated for each predetermined area are different from each other. The predetermined areas may be configured by dividing the entire grayscales of the image data signal into at least two areas.

At least one of the above and other advantages may be realized by providing an image signal correction system, including a luminance and color measurer that measures luminance and color of a display unit having a plurality of pixels that emit light according to a test image data signal transmitted to the display unit, a sample acquisition unit that acquires at least one luminance measured value and color measured value among luminances and colors of the display unit, a correction operator comparing the acquired luminance measured value and color measured value with a luminance target value and a color target value corresponding to the predetermined test image data signal, and generating a look-up table that represents a correction amount of the test image data according to the comparison result, and a memory unit storing the look-up table.

The measured value and the target value may be measured optical tristimulus values with respect to a luminance measured value and a color measured value acquired by light emission measurement of the display unit and target optical tristimulus values with respect to a luminance target value and a color target value. \

The correction amount of the test image data may include a correction value obtained by comparing measured optical tristimulus values from at least one light emitting portion of the display unit displaying the test image data with target optical tristimulus values, and correcting a corresponding color-specific data signal from a measured optical tristimulus value having a largest difference from a corresponding target optical tristimulus value, and a correction value obtained by iteratively correcting the color-specific data signal corresponding to measured optical tristimulus value until the measured optical tristimulus value converges to the target tristimulus value. Iteratively correcting the color-specific data signal may include adding or subtracting compensating R, G, or B grayscale data to corresponding R, G, or B grayscale data.

The image signal correction system may further include an interpolator that generates an interpolated image corresponding to an image data signal of the display unit, to which the correction amount of the look-up table is applied.

At least one of the above and other features and advantages may be realized by providing an image signal correction method, including transmitting a test image data signal to a display unit, measuring luminances and colors of the display unit emitting light according to the test image data signal, acquiring at least one luminance measured value and color measured value among the luminances and colors, comparing the acquired luminance measured value and color measured value with a luminance target value and a color target value corresponding to the test image data signal, generating a look-up table that represents a basic correction amount of the test image data according to the comparison result, and controlling an image data signal supplied to the display unit according to the look-up table.

Generating the look-up table may include iteratively acquiring a correction amount of the test image data that converges the luminance measured value and color measured value to the luminance target value and color target value, and generating a final look-up table when the luminance measured value and color measured value converge to the luminance target value and color target value to store the acquired correction amount, wherein controlling the image data signal supplied is according to the final look-up table.

The measured value and the target value may be measured optical tristimulus values with respect to a luminance measured value and a color measured value acquired by light emission measurement of the display unit and target optical tristimulus values with respect to a luminance target value and a color target value.

Generating the look-up table may include comparing measured optical tristimulus values from at least one light emitting portion of the display unit displaying the test image data with target optical tristimulus values, and correcting a corresponding color-specific data signal from a measured optical tristimulus value having a largest difference from a corresponding target optical tristimulus value.

Correcting the color-specific data signal may include adding or subtracting compensating R, G, or B grayscale data to corresponding R, G, or B grayscale data.

Generating the look-up table may include comparing measured optical tristimulus values from at least one light emitting portion of the display unit displaying the test image data with target optical tristimulus values, and correcting a corresponding color-specific data signal from a measured optical tristimulus value having a largest difference from a corresponding target optical tristimulus value, and generating a look-up table by iteratively correcting the color-specific data signal corresponding to measured optical tristimulus value until the measured optical tristimulus value converges to the target tristimulus value.

Iteratively correcting the color-specific data signal may include adding or subtracting compensating R, G, or B grayscale data to corresponding R, G, or B grayscale data.

Generating the look-up table may include generating an interpolated image that corresponds to an image data signal of the display unit, to which the correction amount of the look-up table is applied.

Controlling the supplied image data signal may include calculating a modulation coefficient, calculating a full correction amount corresponding to the supplied image data signal using the modulation coefficient and the basic correction amount of the look-up table, correcting the supplied image data signal using the full correction amount, and outputting a corrected image data signal.

Controlling the supplied image data signal may include dividing the supplied image data signal into predetermined areas according to grayscale data, calculating a modulation coefficient to be applied to the image data signal divided into the predetermined areas, calculating a full correction amount corresponding to the divided image data signal using the modulation coefficient and the basic correction amount of the look-up table corresponding to a location of the supplied image data signal, correcting the divided image data signal by the calculated correction amount, and outputting a corrected image data signal for each of the predetermined areas.

Modulation coefficients for each of the predetermined areas may be different from each other. The predetermined areas may be configured by dividing the entire grayscales of the image data signal into at least two areas.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a structure of a display device in accordance with an embodiment.

FIG. 2 illustrates a block diagram of a structure of an image signal correction system in accordance with an embodiment.

FIG. 3 illustrates a flowchart of an image signal correction method in accordance with an embodiment.

FIG. 4 illustrates a luminance and color correction algorithm of the image signal correction method in accordance with an embodiment.

FIG. 5 illustrates a schematic diagram of an image data signal controlled by a controller of the display device of FIG. 1 in accordance with an embodiment.

FIG. 6 illustrates a modulation coefficient graph for low-grayscale data used in a low-grayscale data controller of FIG. 5 in accordance with an embodiment.

FIG. 7 illustrates a modulation coefficient graph for high-grayscale data used in a high-grayscale data controller of FIG. 5 in accordance with an embodiment.

FIG. 8 illustrates a graph of luminance convergence of the display unit through the image signal correction method according to an exemplary embodiment.

FIG. 9 illustrates a graph of luminance and color uniformity through the image signal correction method according to the exemplary embodiment of the present invention.

### DETAILED DESCRIPTION

Korean Patent Application No. 10-2010-0026853, filed on Mar. 25, 2010, in the Korean Intellectual Property Office, and entitled: “Display Device, Image Signal Correction System, and Image Signal Correction Method,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Constituent elements having the same structures throughout the embodiments are denoted by the same reference numerals and are described in a first exemplary embodiment. In the subsequent exemplary embodiments, only the constituent elements other than the same constituent elements are described.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

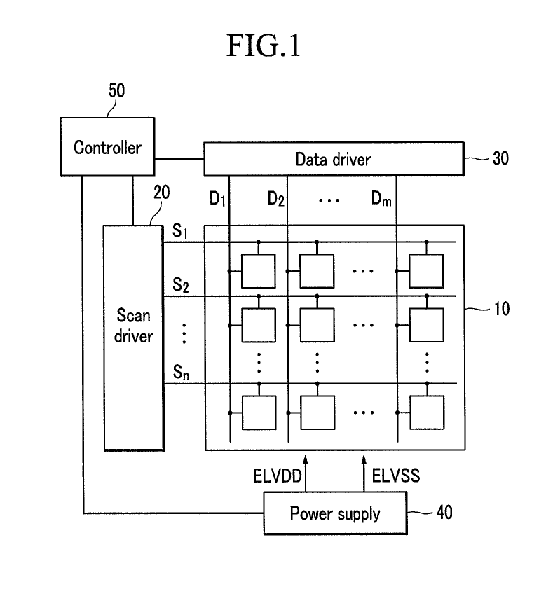

FIG. 1 illustrates a block diagram of a structure of a display device according to an exemplary embodiment. Referring to FIG. 1, a display device according to an exemplary embodiment may include a display unit 10, a scan driver 20, a data driver 30, a power supply 40, and a controller 50.

The display unit 10 may include an organic light emitting diode (OLED) panel (not shown) having a plurality of pixels arranged therein. Each pixel therein emits light corresponding to a driving current flow according to a data signal transmitted from the data driver 30. The display unit 10 also includes a plurality of scan lines S1 to Sn transmitting a scan signal arranged in the row direction and a plurality of data lines D1 to Dm transmitting a data signal arranged in the column direction, with each pixel being located at a corresponding intersection of the scan and data lines. The display unit 10 is driven with first power ELVDD and second power ELVSS supplied from the power supply 40.

The scan driver 20 is connected with the scan lines S1 to Sn to transmit each of the plurality of scan signals to the corresponding scan line among the plurality of scan lines. The data driver 30 generates a plurality of data signals with an image data signal transmitted from the controller 50 and is synchronized at a time that the plurality of scan signals are respectively transmitted to the corresponding scan lines so as to transmit the plurality of data signals to the corresponding data lines, respectively. Then, a data signal output from the data driver 30 is transmitted to a pixel of the display unit 10 receiving the scan signal so that a driving current corresponding thereto flows to the OLED of the pixel.

The controller 50 is connected with the scan driver 20, the data driver 30, and the power supply 40. The controller 50 receives an image signal, a synchronization signal, and a clock signal from an external source to generate control signals that control the scan driver 20, the data driver 30, and the power supply 40, and transmits the same thereto, respectively. For example, the controller 50 may receive an RGB image signal having red, blue, and green components, and may generate an image data signal in response thereto.

The scan driver 20 generates a plurality of scan signals according to the control signal transmitted from the controller 50 and transmits the same to the plurality of scan lines. The data driver 30 generates a plurality of data signals according to the control signal and the image data signal transmitted from the controller 50 and transmits the same to the plurality of data lines.

In the display device in FIG. 1, measured luminance of the display device may be lower than desired luminance. When the measured luminance is different from the desired luminance, the display device may be determined to be faulty. Therefore, luminance is corrected by the amount of a difference therebetween. However, when an existing method that performs correction using an internal circuit of a pixel is applied to a large-sized display unit, problems not at issue in small-sized displays, e.g., as power IR drop, non-uniformity, and loading effect, are not addressed. In addition, it may be difficult to correct wave shift according to a location in a large-sized display unit, memory size needed for correction may be increased, yield may be decreased, and production cost may be increased.

When only the luminance is increased for correction, white balance may be incorrect due to efficiency differences of R, G, and B OLEDs. Thus, color coordinates should be corrected after luminance of the display device has been corrected in order to maintain the white balance. In other words, when luminance and color are individually corrected, luminance may become incorrect again if the color is corrected after correcting luminance. Accordingly, accurate and precise correction of luminance and color for image quality improvement of a display device having a large-sized display unit is difficult.

Thus, the controller 50 of the display device according to an exemplary embodiment corrects an image data signal to enhance image quality by improving uniformity by simultaneously correcting of luminance and color in a display device, e.g., in display devices having mid-sized and large display panels.

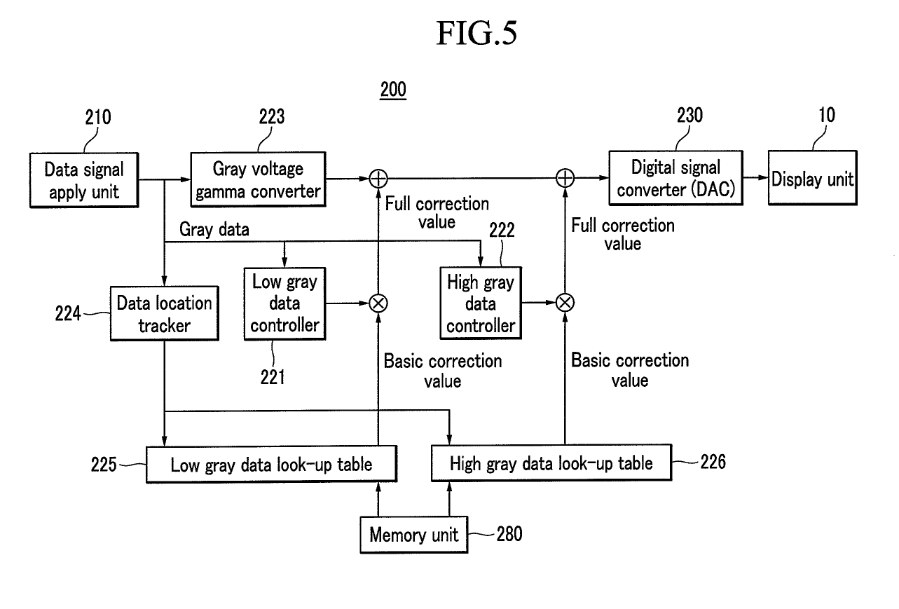

A process for substantial correction of an image data signal using a look-up table generated and stored by an image signal correction system according to another exemplary embodiment of will be described below with reference to FIG. 5.

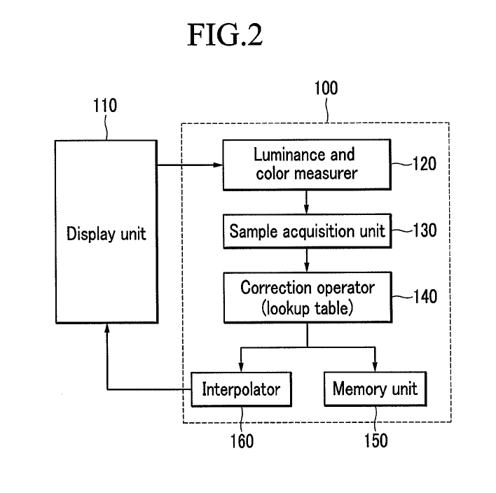

FIG. 2 is a block diagram of a structure of an image signal correction system 100 according to an exemplary embodiment. FIG. 2 schematically shows a relationship between a display unit 110 of a display device, i.e., a target of image signal correction, and an image signal correction system 100.

Referring to FIG. 2, the image signal correction system 100 according to the present exemplary embodiment includes a luminance and color measurer 120, a sample acquisition unit 130, a correction operator 140, a memory unit 150, and an interpolator 160.

The display unit 110 includes a plurality of pixels, and receives a plurality of test image data signals corresponding to a test image data signal representing a test image for image signal correction. Thus, the plurality of pixels of the display unit 110 emits light according to the plurality of test image data signals and the test image is displayed on the display unit 110. The display unit 110 may be the display unit 10 of FIG. 1.

The luminance and color measurer 120 measures luminance and color of the test image displayed on the display unit 110. The test image may be a white screen having a specific luminance. The luminance and color measurer 120 may measure luminance and color of the entire area of the display unit 110 or luminance and color of only part of the display unit 110.

The luminance and color measurer 120 is not limited to any particular device. That is, a luminance and color measurer according to a conventional technology may be used. For example, a two-dimensional optical measurer, e.g., two-dimensional colorimeter, that can optically measure light emission of the display unit 110 may be used, such that two-dimensional luminance and two-dimensional color of the display unit 110 can be measured.

The sample acquisition unit 130 acquires information on luminance and color of the test image measured by the luminance and color measurer 120 by sampling. Hereinafter, a test image displayed on the display unit 110 is referred to as a display test image.

The sample acquisition unit 130 may divide the display unit 110 into a plurality of areas and may acquire information on luminance and color using measured luminance and color corresponding to each area. For example, the sample acquisition unit 130 may divide the display unit 110 in a lattice pattern and generate luminance and color information by sampling (hereinafter, referred to as lattice sampling) luminance and color transmitted from the luminance and color measurer 120 for each of the plurality of areas of the lattice pattern. In this case, the size of each area of the lattice pattern may be set according to the size of the display device and desired accuracy of correction. For example, the lattice sampling may be performed with high density for enhancing accuracy of the correction or may be performed with low density for saving storage capacity of the memory unit 150. For example, lattice sampling may be performed on units having a size of 121×69 pixels for 1920×1080 Full HD.

Hereinafter, the luminance and color information generated by the sample acquisition unit 130 is referred to as a luminance measured value and a color measured value. A luminance measured value and a color measured value of each area of the display unit 110 acquired after the lattice sampling are transmitted from the sample acquisition unit 130 to the correction operator 140.

The correction operator 140 generates a matrix representing the entire area of the display unit 110 by arranging luminance measured values and color measured values of the respective areas, and performs an algorithm to generate a look-up table for the display device using the generated matrix. In particular, the correction operator 140 may compare a luminance measured value and a color measured value of each area with a luminance target value and a color target value of each area corresponding to the test data signal. In addition, the correction operator 140 may determine a correction amount of the test image data for convergence of the luminance and color measured values to the luminance and color target values using the comparison result.

In the image signal correction system according to this exemplary embodiment, the luminance measured value, the color measured value, the luminance target value, and the color target value may be represented with optical tristimulus values CIE X, Y, and Z. The correction operator 140 compares the optical tristimulus values (hereinafter, referred to as a measured tristimulus value) corresponding to the luminance and color measured values and optical tristimulus values (hereinafter, referred to as a target tristimulus value) corresponding to the luminance and color target values, and corrects the test image data in order to gradually decrease a difference therebetween. A stimulus value, i.e., CIE X, Y, or Z, having the largest difference between the measured tristimulus values and the target tristimulus values may first be corrected among the stimulus values. The correction operator 140 may generate a look-up table that stores a correction amount that is updated at each step of test image signal correction. That is, when the look-up table is updated, a correction amount updated at each step may be included. The look-up table of the correction operator 140 stores the correction amount for convergence of the measured tristimulus values to the target tristimulus values.

The test image data signal correction in the image signal correction system according to this exemplary embodiment may be performed on test grayscale data generated through gamma conversion of the test image data signal according to the gamma characteristic of the display unit. When a test image is displayed on the display unit 110, the test grayscale data includes a plurality of R, G, and B grayscale data that determine a light emission degree of each of a plurality of R color pixels, a plurality of G color pixels, and a plurality of B color pixels.

The look-up table generated through the above process may be stored in the memory unit 150. The memory unit 150 may store all the information acquired through the image signal correction process according to the exemplary embodiment. In particular, the memory unit 150 may store the look-up table having correction data corresponding to the test image data signal.

The interpolator 160 performs test image data signal correction based on the look-up table generated by the correction operator 140, and 2D-interpolates the corrected test image data signal with a 2D patterning program according to resolution of the display unit 110. After the 2D interpolation, the test image data signal may be converted into a plurality of data signals and transmitted to the display unit 110, luminance and color of the display test image may be measured again, and a luminance measured value, a color measured value, a luminance target value, and a color target value may be compared again. Based on the comparison result, the correction amount of the test image data signal may be re-set and a test image data signal in which the correction amount is reflected may be two-dimensionally interpolated. The interpolated test image data signal may be converted again into a plurality of data signal and then transmitted again to the display unit 110.

Through repetition of the above-described process, the difference between the measured values and the target values gradually decreases so that the measured values approach the target values. When the difference between the measured values and the target values is below a predetermined value, the correction process may be terminated and final correction data may be stored in the look-up table. The predetermined value may be set according to an offset range between the measured values and the target values allowed in design.

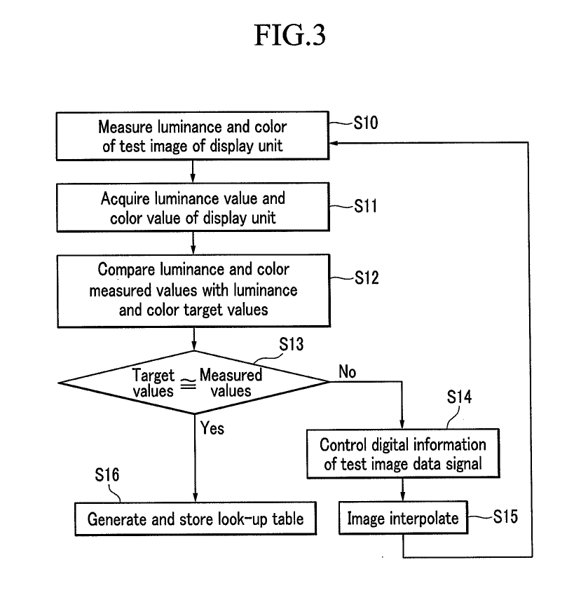

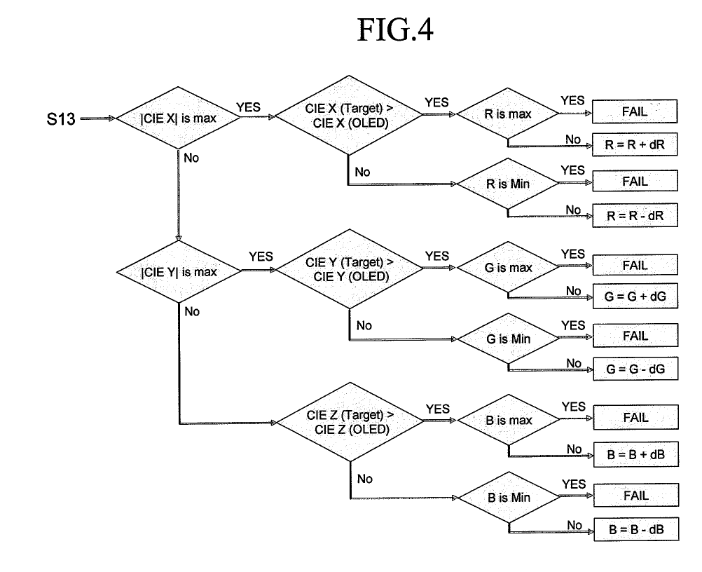

FIG. 3 illustrates a flowchart of an image signal correction method according to an exemplary embodiment. FIG. 4 illustrates an iterative convergence algorithm of a luminance measured value and a color measured value in the method illustrated in FIG. 3 according to an exemplary embodiment.

Referring to FIG. 3, an image data signal, i.e., a test image data signal, is transmitted to the display unit 110 to measure luminance and color according to the result of measuring an image on the display unit (S10). The light emission of the display unit may be measured using an optical measurer, allowing faster luminance and color measurement and faster extraction of a look-up table by optically measuring luminance and color.

Luminance and color of a display test image displayed corresponding to the test image data signal are sampled to acquire a luminance measured value and a color measured value (S11). The sampling method is the same as the previously described method.

The acquired luminance and color measured values and luminance and color target values corresponding to a predetermined test image data signal are compared (S12). The luminance measured value and color measured value extracted from light emission luminance and color of the display unit and the luminance target value and color target value may be respectively represented as optical tristimulus values. That is, when a test image is displayed on the display unit, measured tristimulus values and target tristimulus values of each of the plurality of areas of the display unit are compared.

Next, whether the measured tristimulus values are sufficiently close to the target tristimulus values (S13) is determined. In further detail, whether the measured tristimulus values are included within an allowable range of the target tristimulus values is determined. If not, digital information of the test image data signal is controlled in operation S14, i.e., digital information is updated so that the measured tristimulus values will get closer to the target tristimulus values when the method begins again at operation S10. That is, the measured value converges to the target value through an algorithm for tristimulus error convergence iteration. In this case, the allowable range of the target tristimulus value is set in consideration of a predetermined error range.

In operation S13, the tristimulus values are sequentially compared with the corresponding target values from a stimulus value having the largest difference among the tristimulus values. When the target value is larger than the measured value, digital information of the corresponding image data signal is increased. In further detail, the test image data signal includes R gray data, G gray data, and B gray data, and the comparison is performed first on the measured stimulus value furthest from the corresponding target stimulus value. For example, when a difference of a stimulus value corresponding to the R gray data is the largest between the measured tristimulus values and the target tristimulus values, digital information of the R gray data is increased or decreased by a predetermined amount. The tristimulus error convergence iteration algorithm will be described in further detail later with reference to FIG. 4.

The image is interpolated based on the controlled test gray data (S15) after the digital information of the test image data signal is controlled in operation S14. Then, controlled digital information is fed back to the display unit for light emission in operation S10 again. Then, luminance and color are measured from the display test image again, and whether the measured values are converged to the target values is determined again. This series of process may be iteratively performed.

When the measured tristimulus values respectively converge to the target tristimulus values in operation S13, a look-up table that represents a difference between the controlled gray data and before-controlled test gray data as a correction amount is generated and stored (S16). When the measured tristimulus values converge to the target tristimulus values, the correction operator 140 generates a final correction amount for convergence of the measured tristimulus values to the target tristimulus values in the look-up table and the look-up table is stored in the memory unit 150. A process for correcting an image signal using the finally generated and stored look-up table will be described in further detail later with reference to FIG. 5.

FIG. 4 illustrates an algorithm for iterative convergence of luminance and color measured values acquired from the display unit to luminance and color target values. Referring to FIG. 4, a method for correcting an image data signal according to an exemplary embodiment uses an algorithm that simultaneously corrects luminance and color by iteratively performing the correction to reduce the difference between measured values and the target values. The algorithm of FIG. 4 shows the method for controlling the digital information of the test image data signal performed in operation S14 in the flowchart of FIG. 3 in further detail.

When the target value is larger than the measured value, a plurality of test image data signals respectively corresponding to a plurality of R, G, and B pixels are increased to converge the measured tristimulus values to the target tristimulus values. In order to increase the plurality of test image data signals, digital information of a test image data signal corresponding to an area of which a measured value and a target value are compared may be controlled upward. The test image data signal according to the exemplary embodiment is a digital signal of a predetermined bit unit, and includes test gray data of R gray data, G gray data, and B gray data that respectively represent R, G, and B. Until the measured value approaches the target value, the R gray data, G gray data, and B gray may be gradually increased by a predetermined unit.

When the target value is smaller than the measured value, the plurality of test image data signals respectively corresponding to the plurality of R, G, and B pixels are decreased for convergence of the measured tristimulus values to the target tristimulus values. In order to decrease the plurality of test image data signals, digital information of a test image data signal corresponding to an area of which a measured value and a target value are compared may be controlled downward. The R gray data, G gray data, and B gray may be gradually decreased by a predetermined unit until the measured value approaches the target value.

In the exemplary embodiment, luminance and color measured values of the test image data signal and luminance and color target values may be represented by an optical tristimulus value. That is, the operation may be performed in a CIE XYZ space rather than in a CIE 1931 or a CIE 1976 space that determines luminance and color.

Referring to FIG. 4, the display unit that receives the test image data signal and emits light with a driving current corresponding to the received signal is optically measured, and luminance and color measured values may be acquired by sampling in the CIE XYZ space. When CIE XYZ values of the luminance and color measured values are obtained, the obtained values are respectively compared with CIE XYZ values of the luminance and color target values to gradually and iteratively reduce a difference therebetween, such that the CIE XYZ values of the luminance and color measured values converge to the CIE XYZ values of the luminance and color target values.

In further detail, color coordinates of luminance and color measured values of the display unit that emits light corresponding to the test image data signal and color coordinates or luminance and color target values corresponding to the test image data signal are converted to CIE XYZ space and a difference between the measured values and the target values is determined. Tristimulus values of the CIE XYZ space may be respectively compared with each other. A tristimulus value having the largest difference may be first corrected so as to approach the target value.

Controlling a tristimulus value of a measured value for convergence to a tristimulus value of a target value may include gradually altering digital information (e.g., 10 bit or 12 bit value) of test gray data including R gray data, G gray data, and B gray data by a predetermined unit to approach the target value.

If current luminance is 200 bit, (x, y) of CIE 1931 can converge to the color coordinate and luminance of 0.28 and 0.29 by converging the tristimulus value of the target value CIE XYZ to 193.1, 200.0, 296.5 as shown in Equation 1.

$$X = \frac{Y}{y} x \\ Z = \frac{Y}{y} ( 1 - x - y ) \qquad [ Equation 1 ]$$

In the image signal correction system 100 shown in FIG. 2, the luminance and color measurer 120 determines luminance and color of the display unit according to a location thereof by measuring light emission of the test image signal of the display unit. Tristimulus CIE XYZ that are converted into the CIE XYZ space from color coordinates of a luminance measured value and a color measured value currently acquired corresponding to a predetermined area sampled by the display unit that emits light with the test image data signal are compared with tristimulus CIE XYZ of the luminance target value and the color target value.

In FIG. 4, the tristimulus value among the tristimulus values CIE XYZ having the largest difference between the present measured value and the target value is converged to tristimulus values of a desired target value by controlling digital information of the test image data signal. For example, if the CIE X has the largest difference, the CIE X target value and the CIE X measured value are compared.

If the CIE X target value is greater than the CIE X measured value, digital information of R grayscale data that represents an R pixel among the test image data signal should be controlled upward in order to approach to the CIE X target value. There will be no correction required (failure state) if an R grayscale data voltage of the measured value equals of exceeds a maximum voltage. However, usually, the R grayscale data voltage of the measured value is less than the maximum voltage. Accordingly, the CIE X measured value converges to the CIE X target value by acquiring digital information of R grayscale data that has been corrected by adding digital information dR of a predetermined bit unit to digital information of the measured R grayscale data.

If the CIE X target is smaller than the CIE X measured value, digital information of an R test image data signal that represents the R pixel should be controlled downward in order to approach the CIE X target value. There will be no correction required (failure state) if the R grayscale data voltage of the measured value is equal to or less that a minimum voltage. However, usually, the R grayscale data voltage of the measured value is greater than the minimum voltage. Accordingly, digital information of R grayscale data that has been corrected by subtracting digital information dR by a predetermined bit unit from digital information of the measured R grayscale data.

After a CIE X having the largest difference is corrected, a stimulus value having the second largest difference may be corrected through the above-described process. For example, a difference of the CIE Y may be the second largest one, and the CIE Y measured value is converged to the CIE Y target value through the same method of the CIE X correction. Finally, the CIE Z measured value is converged to the CIE Z target value through the above-described process.

The convergence order in the algorithm of FIG. 4 is one exemplary embodiment of the image signal correction method, and is not restricted thereto. In addition, the algorithm of FIG. 4 may be iteratively performed until the measured tristimulus values converge to the target tristimulus values.

Iterative convergence to the target tristimulus values through the algorithm of FIG. 4 has a merit in that luminance and color at every location of the display unit may converge to the target values. However, the number of iterations using a set predetermined unit to alter the digital information may become too large. Thus, according to an exemplary embodiment, digital information dR, dG, and dB with respect to R, G, and B grayscale data voltage difference used for correction of R, G, and B grayscale data may be acquired using proportional values that correspond to difference value resulted from comparison between measured tristimulus values and target tristimulus values.

Using the algorithm of FIG. 4, the R, G, B grayscale data correction process may be performed as many times as the size of the extracted lattice sample area of the display unit. For example, when the lattice sampling is performed with about 121×69 size in 1920×1080 Full HD, a luminance and color correction algorithm may be performed 8349 times (i.e., (121×69) times) for each of the extracted pixel samples.

After the algorithm for correcting luminance and color measured by lattice sampling of the display unit is performed, digital information corresponding to a difference between R, G, and B grayscale data after correction and R, G, and B grayscale data before correction is defined by a correction amount and a look-up table that represents the correction amount is generated and stored.

The look-up table that represents the RGB correction amounts may be generated through various levels for each light emission luminance of the display unit. For example, the look-up table may be generated through three luminance levels, e.g., 200 nit, 100 nit, and 50 nit, or may be generated through two luminance levels, e.g., 200 nit and 50 nit.

When the RGB look-up table is gradually generated for each luminance level, mura or non-uniformity occurring due to various reasons can be solved using the look-up table even though the mura or non-uniformity occurs in various grayscale levels, e.g., a high-grayscale level and a low-grayscale level. As a result, each look-up table of the RGB correction amount that is the same as the lattice sampling in size may be generated, and as many look-up tables may be generated and stored as there are grayscale levels. The look-up table according to an exemplary embodiment may be ±8 bit with reference to the center point of the display unit.

FIG. 5 illustrates a schematic diagram of control of image data signal performed in the controller 50 of the display device of FIG. 1. That is, a schematic diagram of the controller 50 that corrects an image data signal using a look-up table of luminance and color of the display unit, obtained using the algorithm of FIGS. 3 and 4. The controller 50 transmits an image data signal as an image data signal corrected using the look-up table to the display unit 10 through the data driver 30.

An image data signal control system 200 that corrects an image data signal and transmits the corrected image data signal to the display unit 10 may include a controller including a data signal apply unit 210, a gray voltage gamma converter 223, and data controllers 221 and 222, a data signal converter 230 of the data driver, and a memory unit 280.

The data signal apply unit 210 provides an image data signal for light emission by the display unit 10. The image data signal may be a test image data signal when the look-up table is obtained through the image signal correction system 100. The data controllers 221 and 222 correct a supplied image data signal using a correction amount obtained by using the image signal correction method according to the exemplary embodiment, and output the corrected image data signal.

In further detail, the data signal apply unit 210 generates gray data using the supplied image data signal and transmits the generated gray data to the data controllers 221 and 222. The grayscale data may be transmitted to the gray voltage gamma converter 223, and the gray voltage gamma converter 223 gamma-corrects the grayscale data according to a characteristic of the display unit to generate gamma-corrected grayscale data. The grayscale data may include R, G, and B grayscale data.

The data controllers 221 and 222 according to the exemplary embodiment may be a plurality of data controllers that divide grayscale data corresponding to the look-up table that represents a correction amount calculated for each of predetermined areas, divided according to a grayscale of the test image data signal for correction. Referring to FIG. 5, the data controllers 221 and 222 according to the exemplary embodiment include a low grayscale data controller 221 and a high grayscale data controller 222 that divide the entire grayscales into a high grayscale area and a low grayscale area and correct an image data signal included in each grayscale area. However, embodiments are not limited thereto, and more than two data controllers may be employed.

The grayscale data of the image data signal supplied through the data signal apply unit 210 is transmitted to the data controllers 221 and 222 of each of the predetermined areas divided according to the grayscale data. If the grayscale of the image data signal is a low grayscale data, e.g., lower than grayscale 128 for 256 grayscale data, the image data signal is transmitted to the low grayscale data controller 221 for adjustment. If the grayscale of the image data signal is a high grayscale, e.g., higher than grayscale 128, the image data signal is transmitted to the high grayscale data controller 222 for adjustment.

In FIG. 5, the controller of the image data signal correction system according to the exemplary embodiment may further include a data location tracker 224. The data location tracker 224 determines a look-up table to be applied according to grayscale data and tracks a location storing a correction amount corresponding to current input grayscale data in the look-up table to be applied.

As previously described, a look-up table of each of grayscales, including RGB correction amounts of luminance and color measured by the display unit that emits light corresponding to the test image data signal, is calculated and then stored in the memory unit 280. The data location tracker 224 may search for a look-up table where a correction amount corresponding to grayscale data is stored in the memory unit 280.

For one example, when grayscale data of an image data signal corresponds to a low grayscale area, the data location tracker 224 may search through the look-up tables stored in the memory unit 280 to find a low gray data look-up table 225 obtained in the low grayscale area and transmit a basic correction value to the low grayscale data controller 221. The basic correction value according to the exemplary embodiment is data including 8-bit digital data representing correction values of the look-up table.

The basic correction value transmitted to the low grayscale data controller 221 is multiplied by a modulation coefficient calculated for each area by the low grayscale data controller 221 and the multiplication result is transmitted as a full correction value. The modulation coefficient is a coefficient corresponding to a supplied image data signal to limit the supplied image data signal to be divided for correction for each correction area. The full correction value may be digital data corresponding to a correction value of a final image data signal having a modulation coefficient for the image data signal considered.

Similarly, when the grayscale data of the image data signal corresponds to a high grayscale area, the data location tracker 224 may search for a location of a correction amount corresponding to the grayscale data in the high gray data look-up table 226 obtained in the high grayscale area and transmit a basic correction value to the high grayscale data controller 222. The high grayscale data controller 222 stores data for a modulation coefficient for each predetermined area, and transmits a full correction value acquired by multiplying the corresponding modulation coefficient by the basic value of the high gray data look-up table 226.

A full correction value calculated for each grayscale data area is added or subtracted according to grayscale data (for an example, 10 bit voltage data) of a gamma-corrected image data signal generated by the gray voltage gamma converter 223 and then transmitted to the data signal converter 230. The data signal converter 230 converts a digital image data signal corrected by a correction amount corresponding to the supplied image data signal to an analog signal and applies the analog signal to the display unit 10.

The data signal converter 230 is a digital to analog converter that converts a digital signal including voltage information corresponding to an image data signal to an analog signal to transmit a data signal to each of the plurality of pixels of the display unit 10 for light emission of an organic light emitting diode of the corresponding pixel with a driving current corresponding to the data signal. The pixels in the display unit 10 emit light according to a driving current corresponding to a corrected data signal.

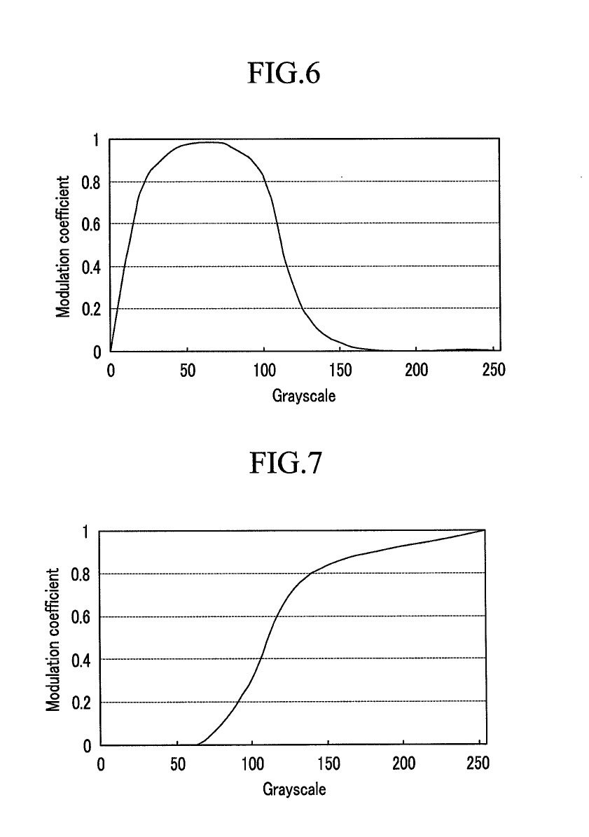

FIG. 6 and FIG. 7 illustrate modulation coefficients of predetermined areas considered for calculation of full correction values from the basic values in the low grayscale data controller 221 and the high grayscale data controller 222. FIG. 6 is a modulation coefficient graph for low-grayscale data of the low grayscale data controller 221. FIG. 7 is a modulation coefficient graph for high-grayscale data of the high grayscale data controller 222.

The modulation coefficient functions to control the look-up table to be available for a specific grayscale according to an input grayscale. For example, the look-up table acquired in the low grayscale may be inappropriate for use with high grayscales, and the look-up table acquired in the high grayscales may be inappropriate for use with the low grayscales. Therefore, the data controller controls correction amounts in the look-up table to be available for each grayscale area by storing information on modulation coefficients appropriately applied to a supplied image data signal.

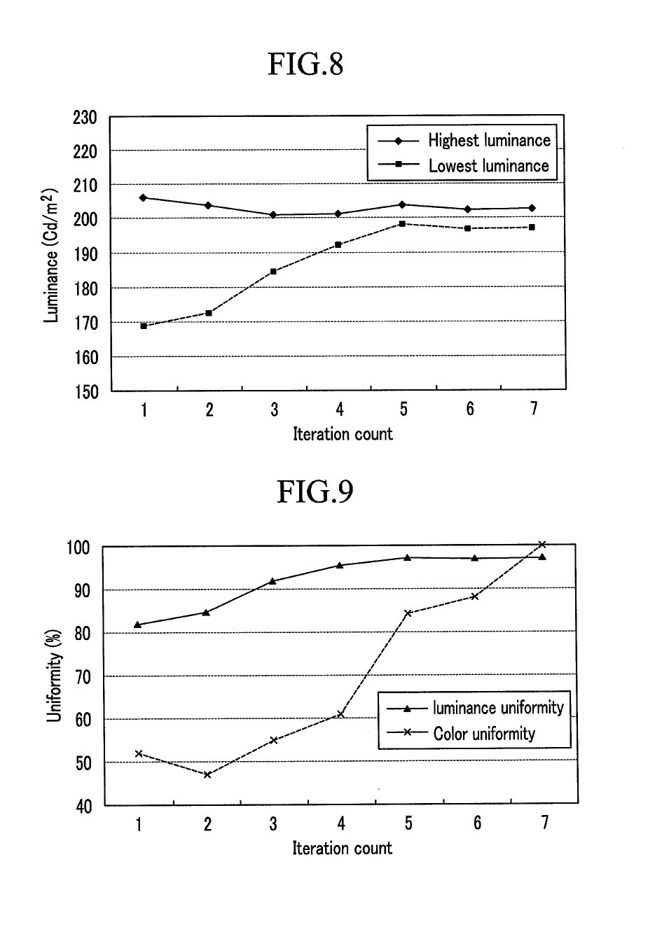

FIG. 8 illustrates a graph of luminance convergence of the display unit through the image signal correction method according to the exemplary embodiment. FIG. 9 illustrates a graph of luminance and color uniformity.

In particular, the graph of FIG. 8 illustrates convergence of currently sampled luminance and color measured values to the luminance and color target values by iteratively correcting differences between the currently sampled luminance and color measured values and the luminance and color target values. Referring to FIG. 8, the highest and lowest measured luminances approach the target luminance, e.g., 200 Cd/m², as the correction of the luminance and color are iteratively performed by the image signal correction system according to the present exemplary embodiment. That is, the highest luminance is corrected downward by an iterative convergence method and the lowest luminance is corrected upward as the number of iteration is increased, such that the measured luminances converge to the target luminance.

In particular, the graph of FIG. 9 shows that both luminance and color uniformity of the display are increased without regard to a screen location as the luminance and color correction is iterated. Accordingly, mura in a thin film transistor and an organic light emitting diode, IR drop, non-uniformity in luminance and color due to non-uniform cavity may be corrected without regard to correction means of an internal driving circuit of a display unit by correcting a supplied image signal using the image signal correction system and the method thereof according to the exemplary embodiments.

While embodiments have been described in connection with what is presently considered to be exemplary embodiments, it is to be understood that the invention is not limited to the disclosed embodiments. A person having ordinary skill in the art can change or modify the described embodiments without departing from the scope of the present invention, and it will be understood that the present invention should be construed to cover the modifications or variations. Further, the material of each of the constituent elements described in the specification can be readily selected from among various known materials and replaced thereby by a person having ordinary skill in the art. Further, a person having ordinary skill in the art can omit some of the constituent elements described in the specification without deteriorating performance or can add constituent elements in order to improve performance. In addition, a person having ordinary skill in the art may change the sequence of the operations described in the specification according to process environments or equipment. Accordingly, the scope of the present invention should be determined not by the above-described exemplary embodiments, but by the appended claims and their equivalents.

### DESCRIPTION OF SYMBOLS

10: display unit
20: scan driver
30: data driver
40: power supply
100: image signal correction system
110: display unit
120: luminance and color measurer
130: sample acquisition unit
140: correction operator
150, 280: memory unit
160: interpolator
200: image data signal control system
210: data signal apply unit
221: low grayscale data controller
222: high grayscale data controller
223: gray voltage gamma converter
224: data location tracker
225: low gray data look-up table
226: high gray data look-up table
230: data signal converter

What is claimed is:

1. A display device, comprising:
a display unit displaying an image of a supplied image data signal;
a scan driver supplying a scan signal to the display unit;
a data driver supplying an image data signal to the display unit according to the scan signal; and
a controller connected with the scan driver and the data driver, the controller generating and transmitting the scan signal and the image data signal,
wherein the controller includes,
a memory unit storing a look-up table of basic correction amounts for a test image data signal according a comparison result of comparing a measured value of an image of the display unit displaying the test image data signal with a target value of the test image data signal; and
a data controller storing data for a modulation coefficient for applying the look-up table to the supplied image data signal, calculating a full correction amount corresponding to the supplied image data signal using the modulation coefficient corresponding to the supplied image data signal and the basic correction amount of the look-up table, and outputting a corrected image data signal by correcting the supplied image data signal using the full correction amount.

2. The display device as claimed in claim 1, wherein the measured value and the target value are measured optical tristimulus values with respect to a luminance measured value and a color measured value acquired by light emission measurement of the display unit and target optical tristimulus values with respect to a luminance target value and a color target value.

3. The display device as claimed in claim 2, wherein the basic correction amount of the test image data is generated from:
a correction value obtained by comparing measured optical tristimulus values from at least one light emitting portion of the display unit displaying the test image data with target optical tristimulus values, and correcting a corresponding color-specific data signal from a measured optical tristimulus value having a largest difference from a corresponding target optical tristimulus value; and
a correction value obtained by iteratively correcting the color-specific data signal corresponding to measured optical tristimulus value until the measured optical tristimulus value converges to the target tristimulus value.

4. The display device as claimed in claim 3, wherein iteratively correcting the color-specific data signal includes adding or subtracting compensating R, G, or B grayscale data to corresponding R, G, or B grayscale data.

5. The display device as claimed in claim 1, wherein the controller further comprises a data location tracker that tracks a location of a correction amount corresponding to grayscale data of a supplied image data signal in the look-up table stored in the memory unit.

6. The display device as claimed in claim 1, wherein the data controller comprises a plurality of data controllers corresponding to predetermined areas partitioned according to grayscale data, each of the plurality of data controllers correcting the image data signal using modulation coefficients calculated for each area and a correction amount of the look-up table stored in the memory unit and outputting a corrected image data signal.

7. The display device as claimed in claim 6, wherein the modulation coefficients calculated for each predetermined area are different from each other.

8. The display device as claimed in claim 6, wherein the predetermined areas are configured by dividing the entire grayscales of the image data signal into at least two areas.

9. An image signal correction system, comprising:
a luminance and color measurer that measures luminance and color of a display unit having a plurality of pixels that emit light according to a test image data signal transmitted to the display unit;
a sample acquisition unit that acquires at least one luminance measured value and color measured value among luminances and colors of the display unit;
a correction operator comparing the acquired luminance measured value and color measured value with a luminance target value and a color target value corresponding to the predetermined test image data signal, and generating a look-up table that represents a correction amount of the test image data according to the comparison result; and
a memory unit storing the look-up table.

10. The image signal correction system as claimed in claim 9, wherein the measured value and the target value are measured optical tristimulus values with respect to a luminance measured value and a color measured value acquired by light emission measurement of the display unit and target optical tristimulus values with respect to a luminance target value and a color target value.

11. The image signal correction system as claimed in claim 10, wherein the correction amount of the test image data comprises:
a correction value obtained by comparing measured optical tristimulus values from at least one light emitting portion of the display unit displaying the test image data with target optical tristimulus values, and correcting a corresponding color-specific data signal from a measured optical tristimulus value having a largest difference from a corresponding target optical tristimulus value; and
a correction value obtained by iteratively correcting the color-specific data signal corresponding to measured optical tristimulus value until the measured optical tristimulus value converges to the target tristimulus value.

12. The image signal correction system as claimed in claim 11, wherein iteratively correcting the color-specific data signal includes adding or subtracting compensating R, G, or B grayscale data to corresponding R, G, or B grayscale data.

13. The image signal correction system as claimed in claim 9, further comprising an interpolator that generates an interpolated image corresponding to an image data signal of the display unit, to which the correction amount of the look-up table is applied.

14. An image signal correction method, comprising:
transmitting a test image data signal to a display unit;
measuring luminances and colors of the display unit emitting light according to the test image data signal;
acquiring at least one luminance measured value and color measured value among the luminances and colors;
comparing the acquired luminance measured value and color measured value with a luminance target value and a color target value corresponding to the test image data signal;
generating a look-up table that represents a basic correction amount of the test image data according to the comparison result; and
controlling an image data signal supplied to the display unit according to the look-up table.

15. The image signal correction method as claimed in claim 14, wherein generating the look-up table comprises:
iteratively acquiring a correction amount of the test image data that converges the luminance measured value and color measured value to the luminance target value and color target value; and
generating a final look-up table when the luminance measured value and color measured value converge to the luminance target value and color target value to store the acquired correction amount, wherein controlling the image data signal supplied is according to the final look-up table.

16. The image signal correction method as claimed in claim 14, wherein the measured value and the target value are measured optical tristimulus values with respect to a luminance measured value and a color measured value acquired by light emission measurement of the display unit and target optical tristimulus values with respect to a luminance target value and a color target value.

17. The image signal correction method as claimed in claim 16, wherein generating the look-up table comprises:
comparing measured optical tristimulus values from at least one light emitting portion of the display unit displaying the test image data with target optical tristimulus values; and
correcting a corresponding color-specific data signal from a measured optical tristimulus value having a largest difference from a corresponding target optical tristimulus value.

18. The image signal correction method as claimed in claim 17, wherein correcting the color-specific data signal includes adding or subtracting compensating R, G, or B grayscale data to corresponding R, G, or B grayscale data.

19. The image signal correction method as claimed in claim 16, wherein generating the look-up table comprises:
comparing measured optical tristimulus values from at least one light emitting portion of the display unit displaying the test image data with target optical tristimulus values, and correcting a corresponding color-specific data signal from a measured optical tristimulus value having a largest difference from a corresponding target optical tristimulus value; and
generating a look-up table by iteratively correcting the color-specific data signal corresponding to measured optical tristimulus value until the measured optical tristimulus value converges to the target tristimulus value.

20. The image signal correction method as claimed in claim 19, wherein iteratively correcting the color-specific data signal includes adding or subtracting compensating R, G, or B grayscale data to corresponding R, G, or B grayscale data.

21. The image signal correction method as claimed in claim 14, wherein generating the look-up table further comprises generating an interpolated image that corresponds to an image data signal of the display unit, to which the correction amount of the look-up table is applied.

22. The image signal correction method as claimed in claim 14, wherein controlling the supplied image data signal comprises:
calculating a modulation coefficient;
calculating a full correction amount corresponding to the supplied image data signal using the modulation coefficient and the basic correction amount of the look-up table;
correcting the supplied image data signal using the full correction amount; and
outputting a corrected image data signal.

23. The image signal correction method as claimed in claim 14, wherein controlling the supplied image data signal comprises:
dividing the supplied image data signal into predetermined areas according to grayscale data;
calculating a modulation coefficient to be applied to the image data signal divided into the predetermined areas;
calculating a full correction amount corresponding to the divided image data signal using the modulation coefficient and the basic correction amount of the look-up table corresponding to a location of the supplied image data signal;
correcting the divided image data signal by the calculated correction amount; and
outputting a corrected image data signal for each of the predetermined areas.

24. The image signal correction method as claimed in claim 23, wherein modulation coefficients calculated for each of the predetermined areas are different from each other.

25. The image signal correction method as claimed in claim 23, wherein the predetermined areas are configured by dividing the entire grayscales of the image data signal into at least two areas.
